(19) United States
(12) Patent Application Publication
(10) Pub. No.: US 2002/0025036 A1
(43) Pub. Date: Feb. 28, 2002

(54) Modem device, data communications system, method of and device for protecting data, and computer product

(75) Inventor: Yasutaka Sato, Tokyo (JP)

Correspondence Address: Kenneth E. Krosin, FOLEY & LARDNER, Washington Harbour, 3000 K Street, N.W., Suite 500, Washington, DC, 20007-5109, US

(73) Assignee: Trinity Communication Inc.

(21) Appl. No.: 09/924,585

(22) Filed: Aug. 9, 2001

(30) Foreign Application Priority Data
Aug. 11, 2000 (JP) 2000-244537

(51) Int. Cl. G06F 11/30; H04L 9/00

(52) U.S. Cl. 380/42; 713/200

(57) ABSTRACT

In the data protection processing device, the protection key adding position determining section or the protection key removal position determining section determines as to whether or not received digital data meets predetermined adding conditions. If the data meets the predetermined adding conditions, encoding and decoding are performed by adding or subtracting a predetermined protection key value to digital data when a predetermined number of items of digital data have been received after the above determination in the protection key adding position determining section or protection key removal position determining section.

### FIELD OF THE INVENTION

The present invention relates to a technology capable of protecting access authority given only to a system manager by encoding and decoding transmission-reception data at the time of access and after communication has been established between only the server and client used by the system manager, when a system manager who controls an LAN inside a company accesses a server belonging to that LAN and also made available via the Internet.

### BACKGROUND OF THE INVENTION

Because the Internet is an open network, there is a drawback that data transmitted by a user has a large possibility of being stolen and read by a third party. Therefore, in communication between a WWW (World Wide Web) server and a WWW browser, which is the general format of communication on the Internet, encryption technology has been introduced in order to guarantee that data that needs to be kept secure such as a credit card number or the like can be transmitted safely, or to guarantee that the contents and sender of mail are not counterfeited.

The common key encryption method and the public key encryption method are known as representative examples of this encryption technology. The common key encryption method is a method in which each of the two parties use the same encryption key to perform encryption and decryption. On the other hand, the public key encryption method is the most common encryption method currently being used. Data that has been encrypted using one of the keys when encryption and decryption are performed using a pair of keys, one of which is a secret key and one of which is a public key, is characterized by the fact that it cannot be decrypted unless the other of the keys is used.

In this public key encryption method, because only the possessor of a secret key (i.e. the person who has the authority to use it) is able to use it freely, that person needs to control it safely by him or her self. On the other hand, a public key is made widely known on the WWW and the like and anybody is able to obtain and use it. Namely, by encrypting data using a secret key and decrypting that data using a public key that completes the pair, effective use certainly becomes possible as it can be confirmed that the data has been encrypted by the person possessing the secret key. Electronic signatures are one phenomenon to make active use of this property of the public key encryption method.

Furthermore, the SSL (Secure Socket Layer) method is known as a representative method for encryption between a WWW server and WWW browser. This SSL method combines the above described common key encryption method and the public key encryption method to make full use of the advantages of both encryption methods.

In particular, in intra-company networks such as an in-house LAN (Local Area Network) there are many examples of the construction of what is known as a VPN (Virtual Private Network) that uses public telephone lines and the above described encryption technology, since this network does not need the financial resources required to maintain a new communication infrastructure such as dedicated lines and the like.

Moreover, in an in-house LAN, in order to make data even more secure, there are many cases of a proxy service being introduced to act as Internet access for an in-house client and thus providing a firewall. A proxy service is a system in which a proxy server located in an in-house network receives and interprets an access request from an in-house client, and then accesses the desired server existing on the Internet, receives the results from there, and passes these to the in-house client.

Using this system, from the Internet it is only possible to see the proxy server and the in-house machine remains completely invisible. On the other hand, the only other party with whom the in-house client is in direct communication is the proxy server and the in-house client is unable to communicate directly with a server on the Internet. As a result, in an in-house LAN it is possible to achieve security of data relative to the outside world. Note that, in some cases, routers and gateways may have the functions of a proxy server.

The system manager of an in-house LAN or the like may in some cases need to access the in-house LAN and control the server not from a client connected directly to the in-house LAN, but from a client installed outside the company. Access to the in-house LAN from outside the company is generally made via a public telephone line and two methods are known. One is a method in which an access server located inside the in-house LAN is accessed (this method is referred to below as the direct access method) and the other is a method in which a WWW server or the like of the in-house LAN is accessed via the Internet after a connection has been made to the access server of an Internet service provider (this method is referred to below as the Internet access method).

In the direct access method, firstly, the system manager makes a dialup connection to the access server of the in-house LAN via a public telephone line using a client machine such as a notebook computer. The access server is connected to the main server of the in-house LAN. The system manager is able via this access server to access the complete range of servers within the in-house LAN. Here, the complete range of servers includes servers for enjoying services that accord with Internet standard protocol such as communication servers, of course, as well as DNS (Domain Name System) servers, mail servers, and WWW servers.

In the Internet access method, firstly, the system manager makes a dialup connection to the access server of an Internet service provider via a public telephone line using a client machine such as a notebook computer. The access server of the Internet service provider is connected to the Internet backbone via a router. Therefore, the system manager is able via this access server to connect to the Internet.

After connecting to the Internet, the system manager accesses servers located in barrier segments, namely, servers such as the WWW servers that are open to the public on the Internet from out of the range of servers in the in-house LAN. At this time, the system manager is able, for example, to access a special WWW page in the WWW server and, by inputting special commands on the homepage displayed first when the WWW server is accessed, to control the various files held by that WWW server.

However, in VPN, when accessing the in-house LAN via a public telephone line and in the transmissions performed after the access is made, it is necessary to perform encryption and decryption processing on all communication data. The increase in the load on the client and server caused by these processings cannot be ignored. In particular, if attempts are made to increase security, the calculations required for the encryption-decryption become more complex. Therefore, there is a need to choose clients and servers that are capable of processing at even faster speeds. This need equates to increased costs when constructing the VPN.

In addition, the size of the data after the encryption is larger than the size of the data before the encryption. This is no problem in the transmission and reception of data of a relatively small size such as is the case with email, however, the time taken by the encryption-decryption processing takes a great deal longer when files of a large size are being transmitted. This is due to the fact that after the entirety of the data that is being transmitted has been received, the encryption-decryption processings are performed once on the whole of that data. Neither is this type of problem with VPN exceptional when a system manager is accessing an in-house LAN.

In the direct access method, when the access server of an in-house LAN is accessed, normally, the input of an ID number and password is requested and access by persons without authority is denied. However, if the dial number of the access server is known by someone, it is possible for that person to move to a state in which the ID number and password are requested even if the person is not the system manager. It cannot be denied that even if the person does not know the ID number and password it may be possible for randomly input numbers and letters to match the ID number and password.

In particular, harmful intruders such as crackers may attempt to get around the authentication provided by the ID number and password using tools that automatically create and automatically input all conceivable combinations of numbers and letters. Accordingly, in the conventional direct access method, it is possible for a person to pose as the system manager by using such tools. The system manager normally has the authority to acquire almost all data including the secret data of the company. Therefore, it is not possible to protect against leaks of this data to the outside world as a result of somebody impersonating the system manager.

On the other hand, even in the Internet access method, the requesting of the input of the ID number and password is in common with when the direct access method is used and it is difficult to afford complete protection against an impersonation of the system manager. In particular, it is to be assumed that there will be unrestricted access to servers in the in-house barrier segments, as they are open to anyone on the Internet. Accordingly, there is a strong possibility that the method of moving to the special WWW page used for system control and to system control mode will also become known. This means that an intruder will eventually arrive at the state where a request is made for the input of the ID number and password used for controlling the system, which means that the problem of the system manager being impersonated will eventually arise.

Furthermore, the conventional VPN, direct access method, and Internet access method are all methods for achieving data security at the application layer level. This means that if an intruder has knowledge of the computer program, then that intruder is able to break down the data security relatively easily without having to use any special equipment. Namely, in the conventional data security technology, from both a cost viewpoint and a time viewpoint, the advantage is with the illegal intruder.

### SUMMARY OF THE INVENTION

It is an object of this invention to provide a modem device, data communications system, method of and device for protecting data, and a computer-readable recording medium that stores a computer program which can realize the method according to the present invention on a computer. The method of and device for protecting data is capable of protecting access authority given only to the system manager when a system manager accesses a server belonging to an LAN in a company without increasing the data size of the transmitted data.

The data protection processing device according to one aspect of this invention comprises a determination unit which reads continuous digital data in sequence and determines whether or not the read digital data forms numerical values having a predetermined continuous pattern; and a calculation unit which adds predetermined calculation values to or subtracts predetermined calculation values from either all of or a portion of a predetermined number of items of digital data that are continuous after digital data that is determined as a result of the determination by the determination unit to form numerical values having the predetermined continuous pattern.

The data protection processing device according to another aspect of this invention comprises a holding unit which converts binary data input serially into byte data and temporarily holds the byte data; a determination unit which sequentially reads the byte data from the holding unit and determines whether or not the read byte data forms a predetermined byte code; a calculation unit which adds predetermined calculation values to or subtracts predetermined calculation values from either all of or a portion of a predetermined number of items of byte data that are continuous after byte data that is determined as a result of the determination by the determination unit to form the predetermined byte code; and an output unit which converts byte data calculated by the calculation unit into binary data and serially outputs the binary data.

The data protection processing device according still to another aspect of this invention comprises a holding unit which converts binary data input serially into byte data and temporarily holds the converted byte data in respective predetermined data frames; a data extraction unit which extracts from the holding unit a portion of the byte data forming the predetermined data frames to serve as data for processing; a determination unit which sequentially reads from the data extraction unit the byte data forming the data for processing and determines whether or not the read byte data forms a predetermined byte code; a calculation unit which adds predetermined calculation values to or subtracts predetermined calculation values from either all of or a portion of a predetermined number of items of byte data that are continuous after byte data that is determined as a result of the determination by the determination unit to form the predetermined byte code; a data frame reconstruction unit which reconstructs the predetermined data frames using byte data calculated by the calculation unit; and an output unit which converts the data frames reconstructed by the data frame reconstruction unit into binary data and serially outputs the binary data.

The data protection processing device according still to another aspect of this invention comprises a first determination unit which sequentially reads transmission data or received data forming continuous digital data and determines whether or not the read transmission data or received data contains digital data having a predetermined numerical value; a first calculation unit which adds predetermined calculation values to or subtracts predetermined calculation values from either all of or a portion of a predetermined number of items of digital data that are continuous after the digital data having the predetermined numerical value when it is determined by the first determination unit that the transmission data or received data contains digital data having a predetermined numerical value; a second determination unit which sequentially reads transmission data or received data forming continuous digital data and determines whether or not the read transmission data or received data contains digital data having a predetermined numerical value; and a second calculation unit which subtracts the predetermined calculation values from or adds the predetermined calculation values to either all of or a portion of a predetermined number of items of digital data that are continuous after the digital data having the predetermined numerical value when it is determined by the second determination unit that the transmission data or received data contains digital data having a predetermined numerical value.

The data protection processing device according still to another aspect of this invention comprises a first holding unit which converts transmission data or received data in the form of serially input binary data into byte data and temporarily holds the byte data; a first determination unit which sequentially reads the byte data from the first holding unit and determines whether or not the read byte data forms a predetermined byte code; a first calculation unit which adds predetermined calculation values to or subtracts predetermined calculation values from either all of or a portion of a predetermined number of items of byte data that are continuous after byte data that is determined as a result of the determination by the first determination unit to form the predetermined byte code; a first output unit which converts byte data added or subtracted by the first calculation unit into binary data and serially outputs the binary data as transmission data or received data; a second holding unit which converts received data or transmission data in the form of serially input binary data into byte data and temporarily holds the byte data; a second determination unit which sequentially reads the byte data from the second holding unit and determines whether or not the read byte data forms a predetermined byte code; a second calculation unit which adds the predetermined calculation values to or subtracts the predetermined calculation values from either all of or a portion of a predetermined number of items of byte data that are continuous after byte data that is determined as a result of the determination by the second determination unit to form the predetermined byte code; and a second output unit which converts byte data added or subtracted by the second calculation unit into binary data and serially outputs the binary data as received data or transmission data.

The data protection processing device according still to another aspect of this invention comprises a first holding unit which converts transmission data or received data in the form of serially input binary data into byte data and temporarily holds the converted byte data in respective predetermined data frames; a first data extraction unit which extracts from the first holding unit a portion of the byte data forming the predetermined data frames to serve as data for processing; a first determination unit which sequentially reads from the first data extraction unit the byte data forming the data for processing and determines whether or not the read byte data forms a predetermined byte code; a first calculation unit which adds predetermined calculation values to or subtracts predetermined calculation values from either all of or a portion of a predetermined number of items of byte data that are continuous after byte data that is determined as a result of the determination by the first determination unit to form the predetermined byte code; a first data frame reconstruction unit which reconstructs the predetermined data frames using byte data calculated by the first calculation unit; a first output unit which converts the data frames reconstructed by the first data frame reconstruction unit into binary data and serially outputs the binary data as transmission data or received data; a second holding unit which converts received data or transmission data in the form of serially input binary data into byte data and temporarily holds the converted byte data in respective predetermined data frames; a second data extraction unit which extracts from the second holding unit a portion of the byte data forming the predetermined data frames to serve as data for processing; a second determination unit which sequentially reads from the second data extraction unit the byte data forming the data for processing and determines whether or not the read byte data forms a predetermined byte code; a second calculation unit which adds the predetermined calculation values to or subtracts the predetermined calculation values from either all of or a portion of a predetermined number of items of byte data that are continuous after byte data that is determined as a result of the determination by the second determination unit to form the predetermined byte code; a second data frame reconstruction unit which reconstructs the predetermined data frames using byte data subtracted or added by the second calculation unit; and a second output unit which converts the data frames reconstructed by the second data frame reconstruction unit into binary data and serially outputs the binary data as transmission data or received data.

The modem device according still to another aspect of this invention comprises a data compression unit which performs data compression processing on digital data to be transmitted based on a normalized data compression standard; a first determination unit which converts digital data that has undergone data compression processing by the data compression unit into byte data, sequentially reads the converted byte data, and determines whether or not the read byte data forms a predetermined byte code; a first calculation unit which adds predetermined calculation values to or subtracts predetermined calculation values from either all of or a portion of a predetermined number of items of byte data that are continuous after byte data that is determined as a result of the determination by the first determination unit to form the predetermined byte code; a first output unit which outputs the byte data added or subtracted in the first calculation unit; a second determination unit which converts received digital data into byte data, sequentially reads the converted byte data, and determines whether or not the read byte data forms a predetermined byte code; a second calculation unit which adds the predetermined calculation values to or subtracts the predetermined calculation values from either all of or a portion of a predetermined number of items of byte data that are continuous after byte data that is determined as a result of the determination by the second determination unit to form the predetermined byte code; and a data decompression unit which converts byte data subtracted or added in the second calculation unit into digital data and performs data decompression processing on the converted digital data based on the data decompression standard.

The data communications system according still to another aspect of this invention comprises a data transmitting device; and a data receiving device which receives data transmitted by the data transmitting device. The data transmitting device includes a first determination unit which reads transmission data in sequence and determines whether or not the read data includes digital data having a predetermined numerical value; a first calculation unit which adds predetermined calculation values to or subtracts predetermined calculation values from either all of or a portion of a predetermined number of items of digital data that are continuous after the digital data having the predetermined numerical value when it is determined by the first determination unit that the data contains digital data having a predetermined numerical value; and a transmitting unit which transmits data that has undergone calculation processing by the first calculation unit. The data receiving device includes a receiving unit which receives data transmitted by the data transmitting unit; a second determination unit which reads in sequence data received by the data receiving unit and determines whether or not the read data includes digital data having the predetermined numerical value; and a second calculation unit which adds the predetermined calculation values to or subtracts the predetermined calculation values from either all of or a portion of the predetermined number of items of digital data that are continuous after the digital data having the predetermined numerical value when it is determined by the second determination unit that the data contains digital data having a predetermined numerical value.

The data communications system according still to another aspect of this invention comprises a data transmitting device; and a data receiving device which receives data transmitted by the data transmitting device. The data transmitting device includes a first holding unit which converts transmission data in the form of serially input binary data into byte data and temporarily holds the byte data; a first determination unit which reads in sequence byte data from the first holding unit and determines whether or not the read byte data forms a predetermined byte code; a first calculation unit which adds predetermined calculation values to or subtracts predetermined calculation values from either all of or a portion of a predetermined number of items of byte data that are continuous after byte data that is determined as a result of the determination by the first determination unit to form the predetermined byte code; and a transmitting unit which converts byte data added or subtracted by the first calculation unit into binary data and transmitting the binary data. The data receiving device includes a second holding unit which converts received data in the form of serially input binary data into byte data and temporarily holds the byte data; a second determination unit which reads in sequence byte data from the second holding unit and determines whether or not the read byte data forms the predetermined byte code; a second calculation unit which adds the predetermined calculation values to or subtracts the predetermined calculation values from either all of or a portion of a predetermined number of items of byte data that are continuous after byte data that is determined as a result of the determination by the second determination unit to form the predetermined byte code; and an output unit which converts byte data added or subtracted by the second calculation unit into binary data and serially outputs the binary data.

The data protection processing method according still to another aspect of this invention comprises a reading step of reading in sequence continuous digital data; a determination processing step of determining whether or not digital data read in the reading step forms numerical values having a predetermined continuous pattern; and a calculation processing step of adding predetermined calculation values to or subtracting predetermined calculation values from either all of or a portion of a predetermined number of items of digital data that are continuous after digital data that is determined as a result of the determination in the determination processing step to form numerical values having the predetermined continuous pattern.

The data protection processing method according still to another aspect of this invention comprises a reading step of converting binary data input serially into byte data and reading the byte data in sequence; a determination processing step of determining whether or not the byte data read in the reading step forms a predetermined byte code; a calculation processing step of adding predetermined calculation values to or subtracting predetermined calculation values from either all of or a portion of a predetermined number of items of byte data that are continuous after byte data that is determined as a result of the determination in the determination processing step to form the predetermined byte code; and an output step of converting byte data calculated in the calculation processing step into binary data and serially outputs the binary data.

The data protection processing method according still to another aspect of this invention comprises a holding step of converting binary data input serially into byte data and temporarily holding the converted byte data in respective predetermined data frames; a data extraction processing step of extracting a portion of the byte data forming the predetermined data frames held in the holding step to serve as data for processing; a determination processing step of sequentially reading from the data extraction processing step the byte data forming the data for processing and determining whether or not the read byte data forms a predetermined byte code; a calculation processing step of adding predetermined calculation values to or subtracting predetermined calculation values from either all of or a portion of a predetermined number of items of byte data that are continuous after byte data that is determined as a result of the determination in the determination processing step to form the predetermined byte code; a data frame reconstruction processing step of reconstructing the predetermined data frames using byte data calculated in the calculation processing step; and an output step of converting the data frames reconstructed in the data frame reconstruction processing step into binary data and serially outputting the binary data.

The data protection processing method according still to another aspect of this invention comprises a reading step of sequentially reading transmission data or received data forming continuous digital data; a first determination processing step of determining whether or not the transmission data or received data read in the reading step contains digital data having a predetermined numerical value; a first calculation processing step of adding predetermined calculation values to or subtracting predetermined calculation values from either all of or a portion of a predetermined number of items of digital data that are continuous after the digital data having the predetermined numerical value when it is determined in the first determination processing step that the transmission data or received data contains digital data having a predetermined numerical value; a second determination processing step of sequentially reading received data or transmission data forming continuous digital data and determining whether or not the read received data or transmission data contains digital data having a predetermined numerical value; and a second calculation processing step of adding predetermined calculation values to or subtracting predetermined calculation values from either all of or a portion of a predetermined number of items of digital data that are continuous after the digital data having the predetermined numerical value when it is determined in the second determination processing step that the received data or transmission data contains digital data having a predetermined numerical value.

The data protection processing method according still to another aspect of this invention comprises a first reading step of converting transmission data or received data in the form of serially input binary data into byte data and sequentially reading the byte data; a first determination processing step of determining whether or not the byte data read in the first reading step forms a predetermined byte code; a first calculation processing step of adding predetermined calculation values to or subtracting predetermined calculation values from either all of or a portion of a predetermined number of items of byte data that are continuous after byte data that is determined as a result of the determination in the first determination processing step to form the predetermined byte code; a first output step of converting byte data added or subtracted in the first calculation processing step into binary data and serially outputting the binary data as transmission data or received data; a second reading step of converting received data or transmission data in the form of serially input binary data into byte data and sequentially reading the byte data; a second determination processing step of determining whether or not the byte data read in the second reading step forms the predetermined byte code; a second calculation processing step of adding the predetermined calculation values to or subtracting the predetermined calculation values from either all of or a portion of a predetermined number of items of byte data that are continuous after byte data that is determined as a result of the determination in the second determination processing step to form the predetermined byte code; and a second output step of converting byte data added or subtracted in the second calculation processing step into binary data and serially outputting the binary data as received data or transmission data.

The data protection processing method according still to another aspect of this invention comprises a first holding step of converting transmission data or received data in the form of serially input binary data into byte data and temporarily holding the converted byte data in respective predetermined data frames; a first data extraction processing step of extracting from the first holding step a portion of the byte data forming the predetermined data frames to serve as data for processing; a first determination processing step of sequentially reading from the first data extraction processing step the byte data forming the data for processing and determining whether or not the read byte data forms a predetermined byte code; a first calculation processing step of adding predetermined calculation values to or subtracting predetermined calculation values from either all of or a portion of a predetermined number of items of byte data that are continuous after byte data that is determined as a result of the determination in the first determination processing step to form the predetermined byte code; a first data frame reconstruction processing step of reconstructing the predetermined data frames using byte data calculated in the first calculation processing step; a first output step of converting the data frames reconstructed in the first data frame reconstruction processing step into binary data and serially outputting the binary data as transmission data or received data; a second holding step of converting received data or transmission data in the form of serially input binary data into byte data and temporarily holding the converted byte data in respective predetermined data frames; a second data extraction processing step of extracting from the second holding step a portion of the byte data forming the predetermined data frames to serve as data for processing; a second determination processing step of sequentially reading from the second data extraction processing step the byte data forming the data for processing and determining whether or not the read byte data forms a predetermined byte code; a second calculation processing step of adding the predetermined calculation values to or subtracting the predetermined calculation values from either all of or a portion of a predetermined number of items of byte data that are continuous after byte data that is determined as a result of the determination in the second determination processing step to form the predetermined byte code; a second data frame reconstruction processing step of reconstructing the predetermined data frames using byte data subtracted or added in the second calculation processing step; and a second output step of converting the data frames reconstructed in the second data frame reconstruction processing step into binary data and serially outputting the binary data as received data or transmission data.

The computer-readable recording medium according still to another aspect of this invention stores a computer program which when executed on a computer realizes the method described above on the computer. This enables the program to be read by the computer resulting in the operations described in the ninth to sixteenth aspects being able to be performed by the computer.

Other objects and features of this invention will become apparent from the following description with reference to the accompanying drawings.

### BRIEF DESCRIPTION OF THE DRAWINGS

FIG. 1 is a block diagram showing the schematic structure of the data protection processing device according to the first embodiment;

FIG. 2 is a flow chart showing the encoding processing of the data protection processing device according to the first embodiment;

FIG. 3 is an explanatory view for describing the addition processing for the protection key values in the data protection processing device according to the first embodiment;

FIG. 4 is a view showing an example of the byte data row obtained by the encoding processing;

FIG. 5 is a flow chart showing the decoding processing of the data protection processing device according to the first embodiment;

FIG. 6 is a view of the system structure showing applied examples of the data protection processing device and data protection processing method according to the second embodiment;

FIG. 7 is a block diagram showing an example modem provide with a data protection function in the data protection processing device and data protection processing method according to the second embodiment;

FIG. 8 is a view of the system structure showing applied examples of the data protection processing device and data protection processing method according to the third embodiment; and

FIG. 9 is a block diagram showing the schematic structure of the data protection processing device according to the third embodiment.

### DESCRIPTION OF THE PREFERRED EMBODIMENTS

Embodiments of the modem device, data communications system, method of and device for protecting data, and the computer-readable recording medium according to the present invention will now be described in detail with reference made to the attached drawings. Note that the present invention is to be in no way limited by the following embodiments.

First, the data protection processing device and data protection processing method according to the first embodiment will be explained. The data protection processing device and data protection processing method according to the first embodiment acquire a byte row by performing byte conversion on a bit data row input serially With the existence of predetermined byte data included in the acquired byte row as a precondition, the data protection processing device and data protection processing method according to the first embodiment are characterized in that they perform the encoding by adding predetermined protection key values to byte data extending from the byte code over a predetermined range. They are also characterized by performing the decoding by reversing this procedure.

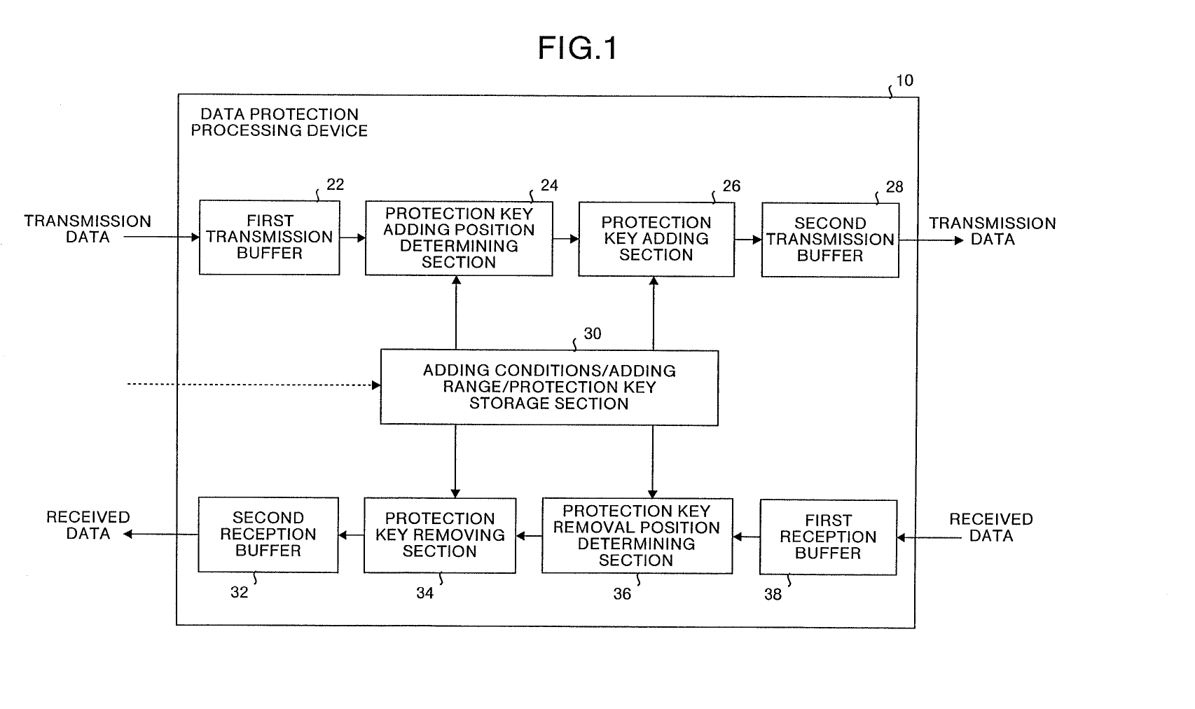

FIG. 1 is a block diagram showing the schematic structure of the data protection processing device according to the first embodiment. The data protection processing device 10 shown in FIG. 1 is provided with an encoding processing section for performing an encoding process on transmission data that is about to be transmitted over a communication line or to a communication device; a decoding processing section for performing a decoding process on received data that is received over a communication line or from a communication device; and with an adding condition/adding range/protection key storage section 30.

The adding condition/adding range/protection key storage section 30 stores the adding conditions, the adding range, and the protection key values. The term “adding conditions” indicates the following. Namely, when byte data indicates a particular byte code, the adding conditions show how many one of the later byte data from that byte data protection key values should be added to. Accordingly, these adding conditions are formed from numerical values that show a predetermined byte code and adding start position.

The adding range indicates how many byte data, beginning from the adding start position indicated by the adding conditions, protection key values are to be added to. The adding range is represented by numerical values that indicate the range. The protection key values, as was described above, represent the numerical values added to the byte data.

The adding conditions, adding range, and protection key values stored in the adding conditions/adding range/protection key storage section 30 are able to be rewritten from the outside. For example, it is possible to employ a format in which the protection key values are all altered at the same moment to predetermined values in synchronization with a time server on the Internet or with the atomic clock of a GPS (Global Positioning System) satellite. The result of this is that stronger data security can be achieved.

Moreover, it is also possible to acquire information relating to the adding conditions, adding range, and protection key values from the data transmitting side and for these to be rewritten by an operator using a keyboard (not shown in the diagrams) based on the acquired information. At this time, it is also possible to prepare conversion tables (not shown) in advance and, by inputting data written using numbers or symbols, to convert this data to data that relates to the adding conditions, adding range, and protection key values using the conversion tables and then input this converted data. In this way, it is possible for personal communication to be carried out between the sender and receiver only.

The encoding processing section is formed from a first transmission buffer 22, a protection key adding position determining section 24, a protection key adding section 26, and a second transmission buffer section 28. The first transmission buffer section 22 is the storage section for accumulating data received from the outside; in particular, serial bit data and data with a capacity to enable at least a plurality of bytes to be formed. In addition, the first buffer section 22 fulfills the function of FIFO (First In First Out) memory in which the serial-parallel conversion of digital data is possible.

The protection key adding position determining section 24 fetches byte data accumulated in the first transmission buffer in the order in which it was accumulated and determines whether or not the fetched byte data matches the byte code indicated by the above described adding conditions. If the byte data fetched from the first transmission buffer meets the above described adding conditions, the protection key adding position determining section 24, for example, places an adding flag indicating that fact in an on state and counts up an adding counter as is described below.

The protection key adding section 26 receives the byte data fetched from the first transmission buffer 22 via the protection key adding position determining section 24 and, if the received byte data meets the above described adding conditions, adds the above protection key values to the byte data. Specifically, the protection key adding section 26 determines whether or not to add the protection key values to the byte data in accordance with the state of the above described adding flag and adding counter.

The second transmission buffer 28 is the storage section for accumulating byte data on which the adding processing has not been implemented and byte data on which the adding processing has been implemented in the protection key adding section 26. The second transmission buffer 28 also functions as FIFO memory in which the parallel-serial conversion of digital data is possible. Accordingly, the encoding processing section only changes the content of the data portion that fulfills predetermined conditions from the data received by the first transmission buffer 22. Particularly characteristic is the fact that there is no change in the data size before and after the change in content.

On the other hand, the decoding processing section is formed from a first reception buffer 38, a protection key removal position determining section 36, a protection key removing section 34, and a second reception buffer 32. The decoding processing section performs the reverse processing to that performed by the above described encoding processing section. The first reception buffer 38 is a storage section that has the same functions as the above described first transmission buffer.

The protection key removal position determining section 36 fetches byte data accumulated in the first reception buffer in the order in which it was accumulated and determines whether or not the fetched byte data matches the byte code indicated by the above described adding conditions. If the byte data fetched from the first reception buffer does match the adding conditions, the protection key removal position determining section 36, for example, places a flag indicating that fact in an on state and counts up an adding counter as is described below. Accordingly, the protection key removal position determining section 36 functionwise operates in the same way as the above described protection key adding position determining section 24. It is thus possible to forego providing the protection key removal position determining section 36 in the decoding processing section and to use the protection key adding position determining section 24 instead.

The protection key removing section 34 receives the byte data fetched from the first transmission buffer 38 via the protection key removal position determining section 36 and, if the received byte data meets the above described adding conditions, subtracts the above described protection key values from the byte data. Specifically, the protection key removing section 34 determines whether or not to subtract the protection key values to the byte data in accordance with the state of the above described adding flag and adding counter.

The second reception buffer 32 is the storage section for accumulating byte data on which the removal processing has not been implemented and byte data on which the removal processing has been implemented in the protection key removing section 34. The second reception buffer 32 also functions as FIFO memory in which the parallel-serial conversion of digital data is possible. Accordingly, the decoding processing section only changes the content of the data portion that fulfills predetermined conditions from the data received by the first reception buffer 38. In particular, it only performs decoding processing on the data whose contents have been changed by the encoding processing section.

Accordingly, if transmission data output from the data protection processing device 10 is not received using the data protection processing device 10, it is not possible to correctly acquire the transmission contents. Namely, the data protection processing device 10 performs encoding and decoding processing in accordance with the contents stored in the adding conditions/adding range/protection key storage section 30 without increasing the size of the data.

Next, a description will be given of the operation of the data protection processing device 10 with the operation separated into encoding processing and decoding processing. Here, in order to simplify the description, the adding start position from among the above described adding conditions will be taken as 1. This refers to the addition or subtraction of the protection key values from the byte data positioned next to the byte code, namely, next to the byte data that acts as the starting signal for the adding processing to be performed.

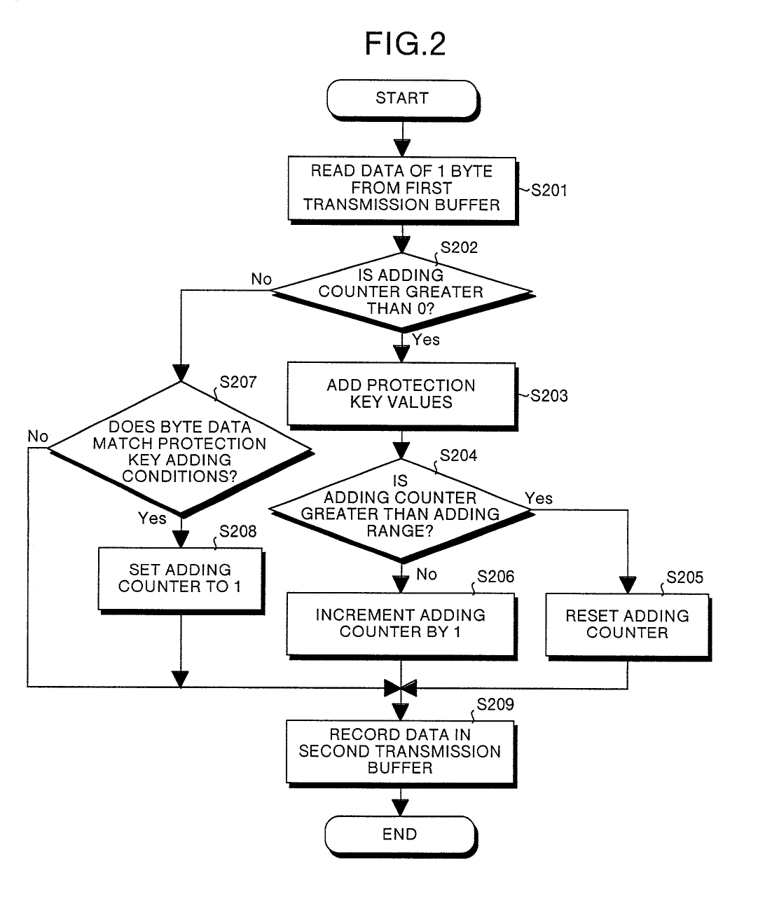

Firstly, a description will be given of the encoding processing of the data protection processing device 10. FIG. 2 is a flow chart showing the encoding processing of the data protection processing device according to the first embodiment. Each time it starts the encoding processing the data protection processing device 10 firstly imports the transmission data that is to be encoded into the first transmission buffer 22. Next, the protection key adding position determining section 24 reads the data of a single byte from the first transmission buffer 22 (step S201). The protection key adding position determining section 24 then makes a determination as to whether or not the adding counter that it controls is showing a value larger than 0 (step S202).

If the adding counter is 0 in step S202, the protection key adding position determining section 24 determines that it is not necessary to carry out the adding processing on the byte data read from the first transmission buffer 22. It also determines whether or not the byte data currently being read matches the protection key adding conditions, namely, the above described byte code (step S207).

If the byte data does not match the protection key adding conditions in step S207, the protection key adding position determining section 24 passes the byte data it is currently reading on to the next stage, namely, the protection key adding section 26 without changing it. The protection key adding section 26 then records the byte data in the second transmission buffer 28 without executing the adding processing (step S209).

If the byte data does match the protection key adding conditions in step S207, the protection key adding position determining section 24 sets the above described adding counter to 1 (step S208) and then executes the processing of step S209.

If the adding counter is larger than 0 in step S202, the protection key adding position determining counter 24 determines that it is necessary to carry out the adding processing on the byte data read from the first transmission buffer 22 and passes the byte data it is currently reading on to the next stage, namely, the protection key adding section 26 and also requests that adding processing be performed on it. As a result, the protection key adding section 26 adds the protection key values stored in the adding conditions/adding range/protection key storage section 30 to the received byte data (step S203).

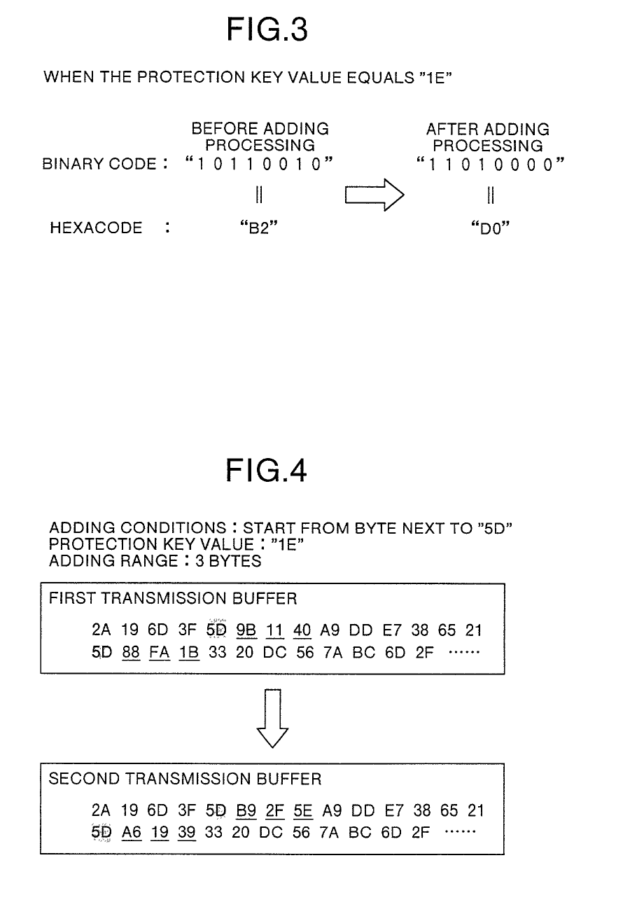

FIG. 3 is an explanatory diagram showing the processing for adding the protection key values. As is shown in FIG. 3, the adding processing in step S203 is performed, for example, by adding the protection key value “1E” to the byte data “B2” when the protection key value is represented in hexacode by “1E” and the data read from the first transmission buffer 22 is byte data represented in binary code by “10110010”, namely, is represented in hexacode by “B2”. Accordingly, in this case, it is possible to obtain, as a result of the addition, byte data represented in binary code by “11010000”, namely, the hexacode “D0”.

When the adding processing by the protection key adding section 26 has been completed, or when a request for adding processing is made to the protection key adding section 26, the protection key adding position determining section 24 determines whether or not the adding counter exceeds the adding range stored in the adding conditions/adding range/protection key storage section 30 (step S204).

If the adding counter does not exceed the adding range in step S204, the protection key adding position determining section 24 increments the value of the adding counter (step S206) and then performs the processing of step S209. If, however, the adding counter does exceed the adding range in step S204, the protection key adding position determining section 24 resets the value of the adding counter (step S205) and then performs the processing of step S209.

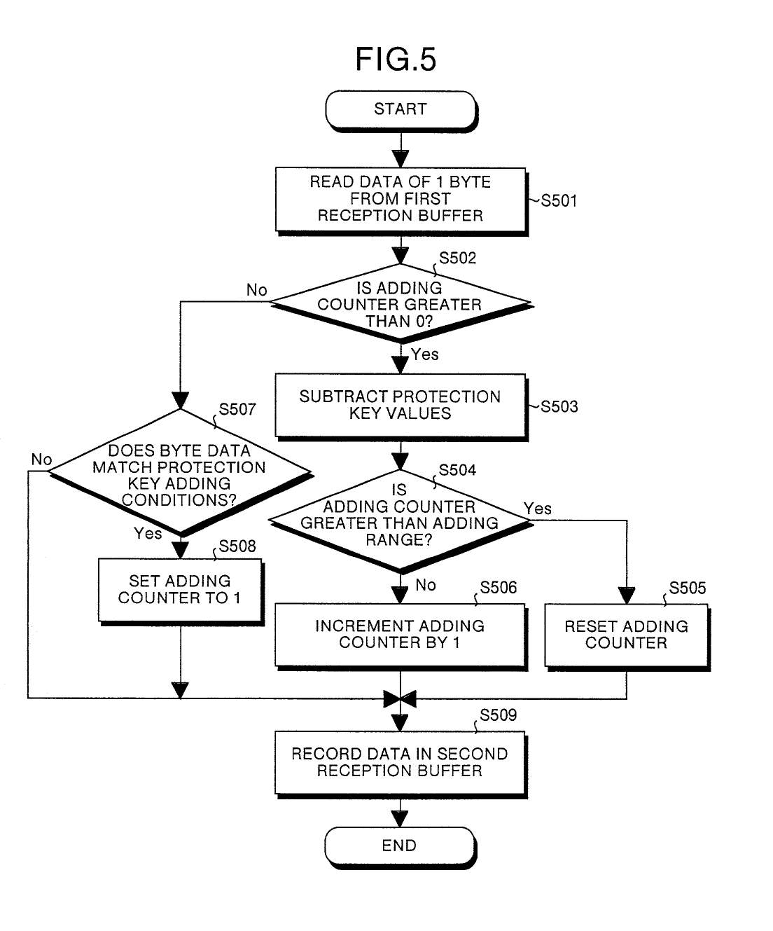

As a result of the above processing, the data protection processing device 10 achieves an encoding of the byte data accumulated in the first transmission buffer 22 that is in accordance with the various conditions stored in the adding conditions/adding range/protection key storage section 30. FIG. 4 shows an example of a byte data row obtained by the encoding processing.

As is shown in FIG. 4, when the adding conditions are set from the byte code next to the byte code “5D”, the protection key value is “1E” and the adding range is 3, as a result of the encoding processing by the data protection processing device 10 the portion “5D 9B 11 40 A9” is changed to “5D B9 2F 5E A9” and the portion “5D 88 FA 1B 33” is changed to “5D A6 19 39 33”. Here, as is the case when “FA” is changed to “19”, if the result when the protection key value is added exceeds the numerical value range represented by one byte, the numerical values of the excess portion is taken as the addition result.

In the above example, only one type of protection key value was set, however, it is also possible to prepare the protection key value as a data pattern formed from a plurality of values and to add or subtract in sequence beginning from the start of the adding range the values shown in sequence by the data pattern. For example, in the example shown in FIG. 4, with the adding conditions and the adding range the same, if the protection key values are set to “1E, AB, 7F”, then “1E” is added to “9B”, which is next to “5D”; “AB” is added to “11”, which comes next; and “7F” is added to “40”, which comes next.

Moreover, it is also possible for the method for setting the adding conditions and adding range to be such as that described below. For example, the adding conditions may be set with the next two from “5D” being missed out so that the next one is three places from “5D” and the adding range then being every second byte from there for a total of 3 bytes. If the example shown in FIG. 4 is used, the subjects of the addition become the third byte “40” (as “9B” and “11” are skipped over) together with “DD” and “38”. In either case, provided that either all or part of a predetermined number of byte data in succession from a byte data of a predetermined numerical value is used, then it doesn't really matter what form the content thereof takes.

A program basically is expressed as an 8 bit data code array. In order to represent numerical values and letters forming commands and the like in the source thereof, only seven bits of the 8 bit code are used and if the eighth bit, which is the most significant bit, is converted to “1”, then the code becomes unrecognizable on a computer. Accordingly, if the data to be protected is a program, then it is even more effective if any one between “80” and “FF” is used as a hexacode such as when the eighth bit is replaced by “1” to form the protection key value.

Next, a description will be given of the decoding processing of the data protection processing device 10. FIG. is a flow chart showing the decoding processing of the data protection processing device according to the first embodiment. Each time it starts the decoding processing the data protection processing device 10 firstly imports the received data that is to be decoded into the first reception buffer 38. Next, the protection key removal position determining section 36 reads the data of a single byte from the first reception buffer 38 (step S501) The protection key removal position determining section 36 then makes a determination as to whether or not the adding counter that it controls is showing a value larger than 0 (step S502)

If the adding counter is 0 in step S502, the protection key removal position determining section 36 determines that it is not necessary to carry out the removal processing on the byte data read from the first reception buffer 38. It also determines whether or not the byte data currently being read matches the protection key adding conditions, namely, the above described byte code (step S507).

If the byte data does not match the protection key adding conditions in step S507, the protection key removal position determining section 36 passes the byte data it is currently reading to the next stage, namely, the protection key removing section 34 without changing it. The protection key removing section 34 then records the byte data in the second reception buffer 32 without executing the removal processing (step S509).

If the byte data does match the protection key adding conditions in step S507, the protection key removal position determining section 36 sets the above described adding counter to 1 (step S508) and then executes the processing of step S509.

If the adding counter is larger than 0 in step S502, the protection key removal position determining counter 36 determines that it is necessary to carry out the subtraction processing on the byte data read from the first reception buffer 38 and passes the byte data it is currently reading to the next stage, namely, the protection key removing section 34 and also requests that subtraction processing be performed on it. As a result, the protection key removing section 34 subtracts the protection key values stored in the adding conditions/adding range/protection key storage section 30 from the received byte data (step S503). Note that because this subtraction processing is the reverse of the addition processing shown in FIG. 3 a description thereof is omitted here.

When the subtraction processing by the protection key removing section 34 has been completed, or when a request for subtraction processing is made to the protection key removing section 34, the protection key removal position determining section 36 determines whether or not the adding counter exceeds the adding range stored in the adding conditions/adding range/protection key storage section 30 (step S504).

If the adding counter does not exceed the adding range in step S504, the protection key removal position determining section 36 increments the value of the adding counter (step S506) and then performs the processing of step S509. If, however, the adding counter does exceed the adding range in step S504, the protection key removal position determining section 36 resets the value of the adding counter (step S505) and then performs the processing of step S509.

As a result of the above processing, the data protection processing device 10 achieves a decoding of the byte data accumulated in the first reception buffer 38 that is in accordance with the various conditions stored in the adding conditions/adding range/protection key storage section 30.

As has been described above, according to the data protection processing device and data protection processing method of the first embodiment, the encoding is achieved by monitoring each byte of the serial data that is about to be sent on a communication line or to a communication device and making a determination as to whether or not that byte data matches a predetermined byte code. If the byte data does match a predetermined byte code, the byte data received a predetermined number of bytes from the location of the match is then taken as a starting position, and predetermined values are added to the byte data extending across a predetermined number of bytes beginning from the byte data in the starting position. As a result, it is possible to achieve an encoding of the data without the size of the data being changed.

Moreover, it is possible to achieve a decoding of data that has undergone the above described encoding by monitoring each byte of the serial data that is sent on a communication line or from a communication device and making a determination as to whether or not that byte data matches a predetermined byte code. If the byte data does match a predetermined byte code, the byte data received a predetermined number of bytes from the location of the match is then taken as a starting position, and predetermined values are subtracted from the byte data extending across a predetermined number of bytes beginning from the byte data in the starting position.

Accordingly, using the data protection processing device and data protection processing method according to the first embodiment, because it is possible to execute encoding and decoding processing in sequence from the portion that is actually received without having to receive all of the digital data of a series of transmitted digital contents, it is possible for the device to be constructed cheaply without there being a need for large volume transmission/reception buffers.

In particular, it is possible to achieve data confidentiality as well as high speed transmission and reception between two parties if both parties are equipped with this data protection processing device.

Note that, in the above described first embodiment, a format in which protection key values are added in the encoding processing and the protection key values are subtracted in the decoding processing is used, however, it is also possible for the format to be reversed and for protection key values to be subtracted in the encoding processing and for the protection key values to be added in the decoding processing.

Furthermore, in the above described data protection processing device according to the first embodiment, it is possible to overwrite from the outside the adding conditions, adding range, and protection key values stored in the adding conditions/adding range/protection key storage section 30.

Next, the data protection processing device and data protection processing method according to the second embodiment will be described. In the second embodiment, an example is described of when the data protection processing device and data protection processing method according to the first embodiment are applied to the aforementioned direct access method. Accordingly, because the contents are the same as those described in the first embodiment, a description thereof will be omitted here.

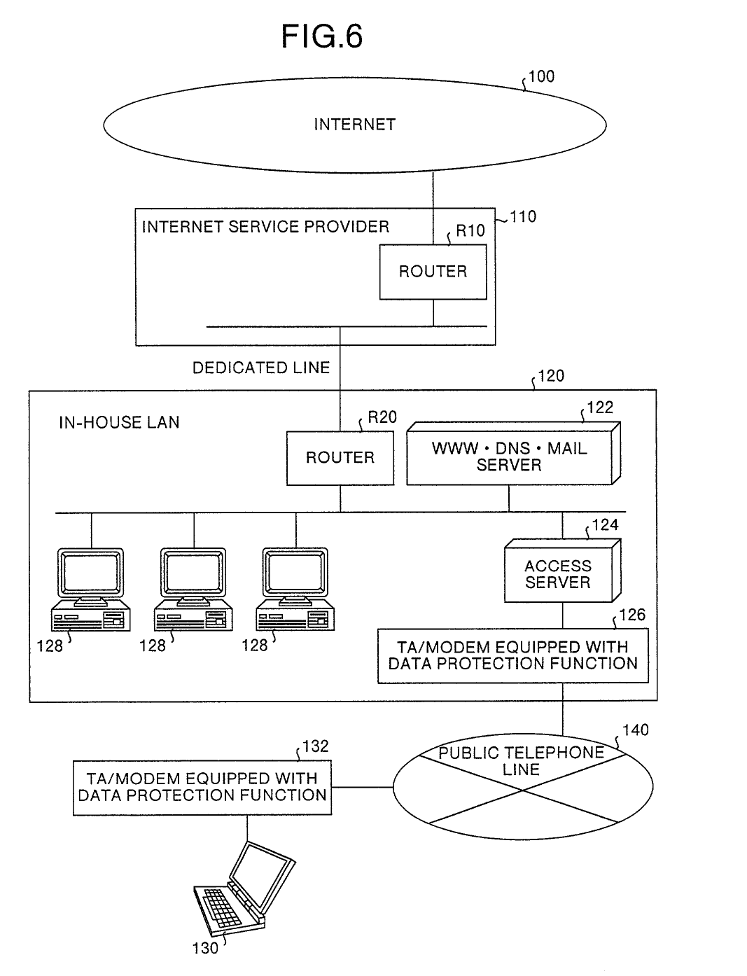

FIG. 6 is a view of the system structure showing an applied example of the data protection processing device and data protection processing method according to the second embodiment. FIG. 6 shown an example in which the client 130 used by the system manager is connected to the access server 124 of the in-house LAN 120 via the public telephone line 140.

As shown in FIG. 6, the in-house LAN 120 is connected to an Internet service provider 110 via a dedicated line. A router R10 of the Internet service provider 110 is connected to the backbone of the Internet 100. As a result, the client 128 in the in-house LAN 120 is able to connect to the Internet 100 via the router R20.

In order to apply the data protection processing device and data protection processing method according to the first embodiment to the direct access method, the TA (Terminal Adaptor)/modem of the client 130 and the TA (Terminal Adaptor)/modem of the access server 124 are both provided with the ability to carry out the data protection processing method described in the first embodiment.

The case when the client 130 is connected to the access server 124 of the in-house LAN will be explained. Firstly, the client 130 establishes a dialup connection by dialing the access server 124.

Next, the access server 124 outputs transmission data showing a request for the input of the ID number and password to the TA/modem 126 equipped with a data protection function. At that point, the transmission data undergoes the encoding processing described in the first embodiment and also undergoes analog conversion and voltage conversion in accordance with the signal standards of the public telephone line 140.

As a result of this, the encoded transmission data arrives at the TA/modem 132 equipped with the data protection function via the public telephone line 140 and there undergoes the decoding processing described in the first embodiment. The decoded transmission data is interpreted by the client 130 and is displayed on the display device of the client 130 as a screen requesting ID number and password input.

The system manager inputs the ID number and password in response to the ID number and password input request. The client 130 outputs the input ID number and password to the TA/modem 132 equipped with a data protection function as transmission data. At that point, the transmission data undergoes the encoding processing described in the first embodiment and also undergoes analog conversion and voltage conversion in accordance with the signal standards of the public telephone line 140.

As a result of this, the encoded transmission data arrives at the TA/modem 126 equipped with the data protection function via the public telephone line 140 and there undergoes the decoding processing described in the first embodiment. The decoded transmission data is interpreted by the access server 124 and confirmation is made of the authenticity of the access, namely, whether or not the access is by the proper system manager.

When validation is made by the access server 124 that the access is by the proper system manager, the access server 124 connects the client 130 to the WWW/DNS/mail server 122 in the in-house LAN 120. As a result, the client 130 is able to access the WWW/DNS/mail server 122 in the in-house LAN 120 and system control as well as file control become possible under the authority of the system manager.

However, because the transmission and reception of data between the client 130 and the WWW/DNS/mail server 122 is still being carried out via the TA/modems 132 and 126 equipped with the data protection function, the encoding and decoding described in the first embodiment are still performed on the input commands and transmitted files when the system control and file control are being performed.

Namely, as long as the TA/modem of the access server 124 installed in the in-house LAN 120 has the data protection function described in the first embodiment, if a client that has a TA/modem also equipped with the same data protection function is used, then it is not possible to access the WWW/DNS/mail server 122 of the in-house LAN from the outside world.

In particular, because it is also not possible to execute the input of the ID number and password requested by the access server 124 if a client that has a TA/modem equipped with the data protection function is not used, it is possible to prevent the problem of “somebody impersonating the system manager” by using an ID number and password automatic generating tool.

Here, if an analog line is used as the public telephone line 140, then both the client 130 and the access server 124 require a modem, however, when converting digital data into analog data, generally, the modem performs data compression and framing.

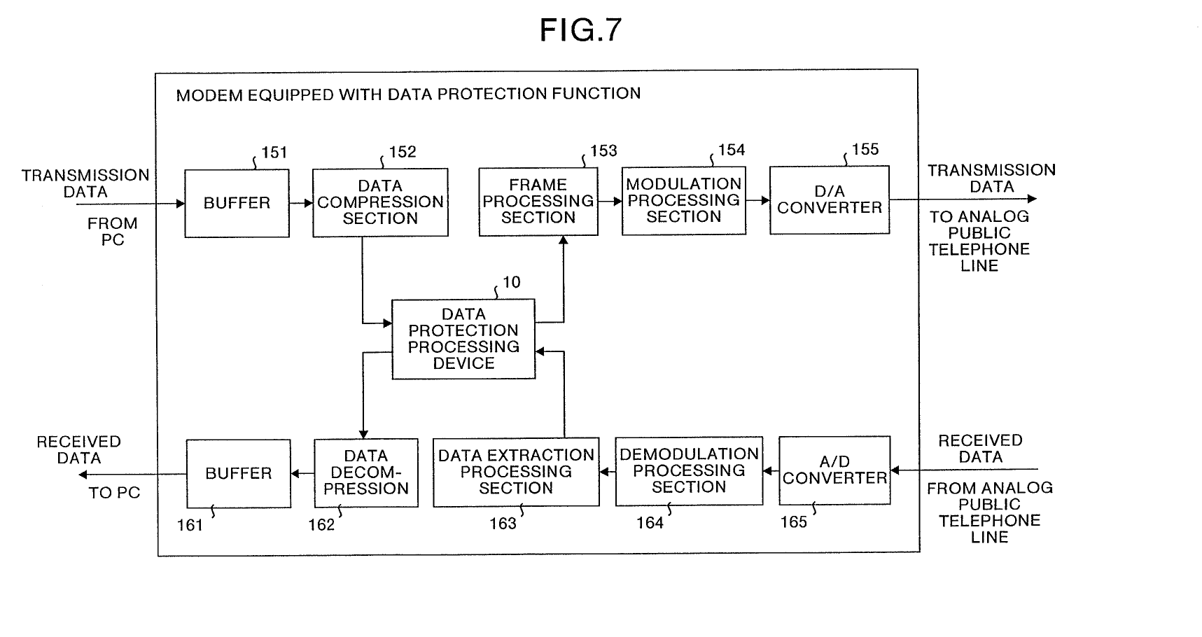

Accordingly, there are a variety of timings present in the modem at which the above described data protection function can be added. FIG. 7 is a block diagram showing an example of a modem equipped with the data protection function. In FIG. 7, the modem equipped with the data protection function is shown provided with the data protection processing device 10 shown in FIG. 1 in addition to a buffer 151, a data compression section 152, a frame processing section 153, a modulation processing section 154, and a D/A converter 155 that form the transmission processing section of a conventional modem, and a buffer 161, a data decompression section 162, a data extraction processing section 163, a demodulation processing section 164, and an A/D converter 165 that form the reception processing section of a conventional modem.

In particular, when transmitting data, the data protection processing section 10 performs encoding processing on the digital data compressed by the data compression section 152 and passes the encoded data on to the frame processing section 153. Moreover, in reverse, when receiving data, the data protection processing section performs decoding processing on the digital data extracted by the data extraction processing section 163 and passes the decoded data on to the data decompression section 162.

As a result, not only is it possible to integrate the modem with the data protection processing device, but because the encoding is performed on compacted data that has already undergone compression, it is also possible to reduce the encoding processing carried out on the transmitted digital contents. This not only makes the transmitting and receiving of data at higher speeds possible, but also ensures the confidentiality of that data.

As has been described above, according to the data protection processing device and data protection processing method of the second embodiment, by imparting the data protection functions described in the first embodiment to the modem/TA of each of the client 130 outside the company and the access server 124 inside the company, normal communication is made possible between only these two. Therefore, only a client having the data protection function is able to access an in-house server permitted to make contact with the outside world by the access server 124 and illegal intrusions from other clients can be prevented.

Furthermore, in the above described data protection processing device according to the second embodiment, only one type of protection key value was set, however, it is also possible to prepare the protection key value as a data pattern formed from a plurality of values and to add or subtract in sequence beginning from the start of the adding range the values shown in sequence by the data pattern.

Furthermore, in the above described data protection processing device according to the second embodiment, in the same way as was described in the first embodiment, it is possible to overwrite from the outside the adding conditions, adding range, and protection key values stored in the adding conditions/adding range/protection key storage section 30.

Next, the data protection processing device and data protection processing method according to the third embodiment will be described. In the third embodiment, an example is described of when the data protection processing device and data protection processing method according to the first embodiment are applied to the aforementioned Internet access method. Accordingly, because the contents described in the first embodiment are the same, a description thereof will be omitted here.

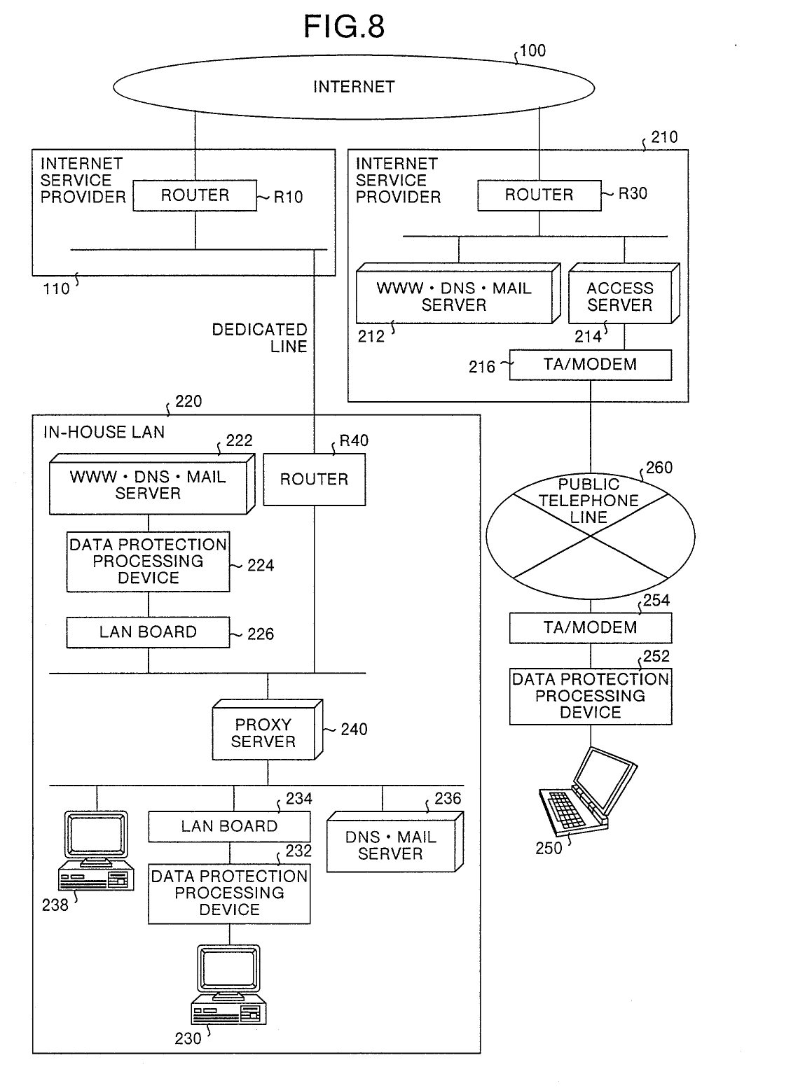

FIG. 8 is a view of the system structure showing an applied example of the data protection processing device and data protection processing method according to the third embodiment. FIG. 8 shows an example in which the client 250 used by the system manager accesses the WWW/DNS/mail server 222 located in a barrier segment of the in-house LAN 220 via the public telephone 260, the Internet service provider 210, the Internet 100 and the Internet service provider 110.

As shown in FIG. 8, the in-house LAN 220 is connected to the Internet service provider 110 via a dedicated line. The router R10 of the Internet service provider 110 is connected to the backbone of the Internet 100. As a result, a client outside the company is able to access the WWW/DNS/mail server 222 located in the barrier segment of the in-house LAN 220 via the Internet 100, the router R10 of the Internet service provider 110, and the router R40 in the in-house LAN 220.

Moreover, the in-house LAN 220 is provided with a proxy server 240 as a firewall. The in-house client 238 filters transmissions between the DNS/mail server 236 for communication inside the company and the WWW/DNS/mail server 222 for communication outside the company, as well as filtering connections to the Internet.

The data protection processing devices according to the first embodiment is provided in each of the client 250 and the WWW/DNS/mail server 222 in the in-house LAN 220 in order for the data protection processing device and data protection processing method according to the first embodiment to be applied to the Internet access method.

In particular, at this time, respective data protection processing devices need to be installed between the TA/modem 254 and the client 250 on the client 250 side and between the LAN board 226 and the WWW/DNS/mail server 222 on the WWW/DNS/mail server 222 side.

Here, among the OSI (Open System Interconnection) reference models on the Internet, communication protocols in which Ethernet is used for the physical layer/data link layer and TCP/IP is used for the transport layer/network layer are the mainstream. Data units, namely, data frames (or alternatively data packets) transmitted and received based on these communication protocols are generated by encapsulating the data that is based on each communication protocol.

For example, the Ethernet frame that is at the lowest layer is formed from an Ethernet data portion and an Ethernet header portion containing MAC (Media Access Control) addresses and the like. The Ethernet data portion is formed from an IP data portion and an IP header portion containing IP addresses and the like. The IP data portion is formed from a TCP data portion and a TCP header portion containing port numbers and the like. Furthermore, the TCP data portion is formed from header portions and data portions such as HTTP (Hypertext Transfer Protocol) and FTP (File Transfer Protocol) located in the application layer.

The network devices that are needed for obtaining LAN and Internet connections read the contents of the header portions of each of the above protocols from the Ethernet frames transferred on the communication line in accordance with the level of the device. For example, the switching hub extracts MAC addresses from the Ethernet header portions and performs path control, while the router extracts IP addresses from the IP header portions and performs path control. Furthermore, in the proxy server, port numbers are extracted from the TCP header portions and filtering is performed.

The data frames that are transferred in this way based on Internet standard protocols have the freedom to change the contents only of the HTTP and FTP data portions of the HTTP application layer level. If data frame structural portions other than these are inadvertently encoded, there is a high risk that the data will not arrive at the transmission destination.

Therefore, in the data protection processing device and data protection processing method according to the third embodiment, a function of specifying the data portion that is to undergo the encoding and decoding from among the data forming the above described data frames is added to the data protection processing device and data protection processing of the first embodiment.

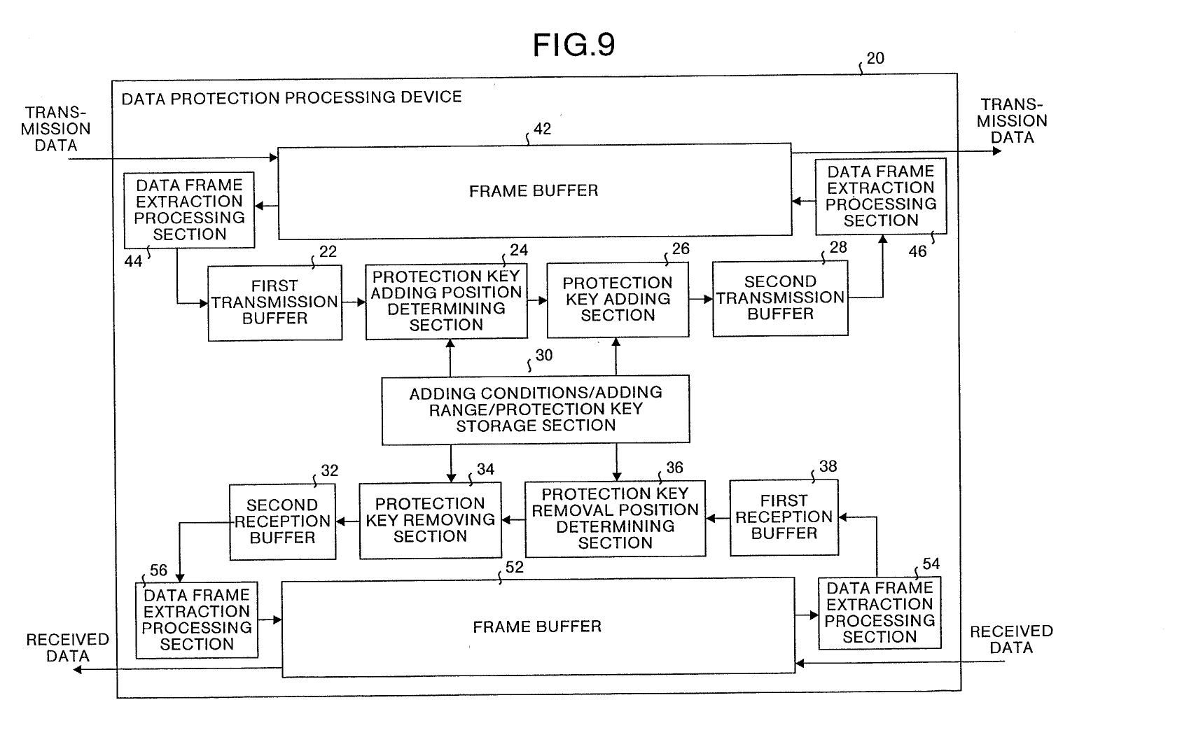

FIG. 9 is a block diagram showing the schematic structure of the data protection processing device according to the third embodiment. Note that in FIG. 9 those portions that are the same as in FIG. 1 are given the same descriptive symbols and a description thereof is omitted. The data protection processing device 20 shown in FIG. 9 differs from that shown in FIG. 1 in that a frame buffer 42, a data frame extraction processing section 44, and a data frame replacement processing section 46 have been added to the encoding section, while a frame buffer 52, a data frame extraction processing section 54, and a data frame replacement processing section 56 have been added to the decoding section.

The frame buffer 42 is a storage section for receiving and holding the data to be transmitted, in particular, the data frames that contain TCP data and IP data positioned at a hierarchy below the application layer. The data frame extraction processing section 44 performs processing to extract data located at the application layer such as HTTP data and the like from the data frames held in the frame buffer 42 and record the extracted data in the first transmission buffer 22.

The data frame replacement processing section 46 performs processing to replace the data portion extracted by the data frame extraction processing section 44 from the data frames held in the frame buffer 42 with data read from the second transmission buffer 28, namely, with data that has undergone the encoding processing described in the first embodiment.

On the other hand, the frame buffer 52 is a storage section for receiving and holding the received data, in particular, the data frames that contain TCP data and IP data positioned at a hierarchy below the application layer. The data frame extraction processing section 54 performs processing to extract data located at the application layer such as HTTP data and the like from the data frames held in the frame buffer 52 and record the extracted data in the first reception buffer 38.

The data frame replacement processing section 56 performs processing to replace the data portion extracted by the data frame extraction processing section 54 from the data frames held in the frame buffer 52 with data read from the second reception buffer 32, namely, with data that has undergone the decoding processing described in the first embodiment.

As a result, it is possible to perform the encoding and decoding processing described in the first embodiment on only that data portion that is not affected by the control of the communication device from among the communication data generated in the client and server.

Next, operation when the system manager uses the client 250 to perform file control of the WWW/DNS/mail server 222 of the in-house LAN 220 will be explained with reference to FIG. 8. The system manager separates the functions of the data protection processing device 252 using a predetermined application program. Namely, the client 250 is placed in a state where it performs normal communication via the TA/modem 254 without the encoding and decoding processing described in the first embodiment being executed.

In this state, the client 250 makes a dialup connection to the access server 214 of the Internet service provider 210 and establishes a connection to the Internet 100 by receiving user validation from access server 214.

The system manager then inputs the URL (Uniform Resource Locator) of the WWW/DNS/mail server 222 of the in-house LAN 220 via a WWW browser. As a result, the client 250 transmits transmission data indicating the WWW page transmission request to the TA/modem 254.

The transmission data transmitted to the TA/modem 254 arrives at the TA/modem 216 of the Internet service provider 210 via the public telephone line 260 and is transferred to the backbone of the Internet 100 via the access server 214 and the router R30.

The transmission data that has been transferred to the backbone of the Internet 100 arrives at the router R10 of the Internet service provider 110 and then arrives at the router R40 of the in-house LAN 220. The transmission data that has arrived at the router R40 then arrives at the WWW/DNS/mail server 222 via the LAN board 226. Note that, at this time, the functions of the data protection processing device 224 have been separated by the WWW/DNS/mail server 222.

Next, the WWW/DNS/mail server 222 returns the data showing the homepage managed by the WWW server portion to the client 250 along the reverse route to that described above.

After receiving the data showing the homepage, the client 250 displays that homepage on the WWW browser and, in that state, inputs a special command used for controlling the system. This command arrives at the WWW/DNS/mail server 222 along the same route as described above. At this time, the client 250 activates the functions of data protection processing device 252 using the aforementioned predetermined application program. In addition, the functions of the data protection processing device 224 are also activated in the WWW/DNS/mail server 222 when it receives the above command.

Accordingly, the communication thereafter between the client 250 and the WWW/DNS/mail server 222 is performed by way of the encoding and decoding processing described in the first embodiment. Therefore, people using other clients are not able to impersonate the system manager and access the WWW/DNS/mail server 222.

As has been described above, according to the data protection processing device and the data protection processing method of the third embodiment, by providing both the client 250 outside the company and the WWW/DNS/mail server 222 inside the company with the data protection processing device described in the first embodiment and activating these data protection processing devices, normal communication between only these two parties is made possible. Therefore, it is possible only for a client having the data protection processing device to access the WWW/DNS/mail server 222 and illegal intrusions from other clients can be prevented.

Note that, in the above described third embodiment, a description is given of when access is made from outside the company to the in-house LAN 220, however, as is shown in FIG. 8, even when access is made from the in-house LAN 220 to the WWW/DNS/mail server 222, by installing the data protection processing devices 232 between the LAN board 234 and the client 230 used by the system manager, it is possible to obtain the same operation and effects as are described above.

Moreover, in the data protection processing devices according to the second and third embodiments described above, in the same way as was described for the first embodiment, only one type of protection key value was set, however, it is also possible to prepare the protection key value as a data pattern formed from a plurality of values and to add or subtract in sequence beginning from the start of the adding range the values shown in sequence by the data pattern.

Furthermore, in the above described data protection processing device according to the third embodiment, in the same way as was described in the first embodiment, it is possible to overwrite from the outside the adding conditions, adding range, and protection key values stored in the adding conditions/adding range/protection key storage section 30.

In addition, the data protection processing method according to the first to third embodiments may be provided in the form of a computer program recorded on a storage medium such as a hard disk, a CD-R drive, or the like, in which case the computer program executes the encoding and decoding processing instead of the above described data protection processing device.

As explained above, according to the data protection processing device of the present invention, a determination is made as to whether or not received digital data is a predetermined numerical value and, if it is determined that it is a predetermined numerical value, the encoding and decoding processing is performed by adding or subtracting predetermined calculation values to the digital data when digital data has been received for a predetermined number of times after the determination is made. Therefore, it becomes possible to execute encoding and decoding beginning in sequence from the portion actually received without having to receive the entire digital data of a string of digital contents that is being transmitted or received. This negates the need for large volume transmission and reception buffers and enables the cost of the device structure to be reduced. In addition, it is possible to achieve data confidentiality as well as high speed transmission and reception between two parties when both are equipped with this data protection processing device.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data protection processing device comprising:
a determination unit which reads continuous digital data in sequence and determines whether or not the read digital data forms numerical values having a predetermined continuous pattern; and
a calculation unit which adds predetermined calculation values to or subtracts predetermined calculation values from either all of or a portion of a predetermined number of items of digital data that are continuous after digital data that is determined as a result of the determination by the determination unit to form numerical values having the predetermined continuous pattern.

2. The data protection processing device according to claim 1, wherein the calculation unit sequentially adds or subtracts calculation values of predetermined data patterns or byte patterns to or from digital data or byte data that is the object of the addition or subtraction.

3. The data protection processing device according to claim 1, further comprising:
a memory which stores information relating to the predetermined numerical values or the predetermined byte code, information relating to the predetermined number of items, and information relating to the predetermined calculation values; and
an information altering unit which alters at least one from among the information relating to the predetermined numerical values or the predetermined byte code, the information relating to the predetermined number of items, and the information relating to the predetermined calculation values that are stored in the memory.

4. A data protection processing device comprising:
a holding unit which converts binary data input serially into byte data and temporarily holds the byte data;
a determination unit which sequentially reads the byte data from the holding unit and determines whether or not the read byte data forms a predetermined byte code;
a calculation unit which adds predetermined calculation values to or subtracts predetermined calculation values from either all of or a portion of a predetermined number of items of byte data that are continuous after byte data that is determined as a result of the determination by the determination unit to form the predetermined byte code; and
an output unit which converts byte data calculated by the calculation unit into binary data and serially outputs the binary data.

5. The data protection processing device according to claim 4, wherein the calculation unit sequentially adds or subtracts calculation values of predetermined data patterns or byte patterns to or from digital data or byte data that is the object of the addition or subtraction.

6. The data protection processing device according to claim 4, further comprising:
a memory which stores information relating to the predetermined numerical values or the predetermined byte code, information relating to the predetermined number of items, and information relating to the predetermined calculation values; and
an information altering unit which alters at least one from among the information relating to the predetermined numerical values or the predetermined byte code, the information relating to the predetermined number of items, and the information relating to the predetermined calculation values that are stored in the memory.

7. A data protection processing device comprising:
a first determination unit which sequentially reads transmission data or received data forming continuous digital data and determines whether or not the read transmission data or received data contains digital data having a predetermined numerical value;
a first calculation unit which adds predetermined calculation values to or subtracts predetermined calculation values from either all of or a portion of a predetermined number of items of digital data that are continuous after the digital data having the predetermined numerical value when it is determined by the first determination unit that the transmission data or received data contains digital data having a predetermined numerical value;
a second determination unit which sequentially reads transmission data or received data forming continuous digital data and determines whether or not the read transmission data or received data contains digital data having a predetermined numerical value; and
a second calculation unit which subtracts the predetermined calculation values from or adds the predetermined calculation values to either all of or a portion of a predetermined number of items of digital data that are continuous after the digital data having the predetermined numerical value when it is determined by the second determination unit that the transmission data or received data contains digital data having a predetermined numerical value.

8. The data protection processing device according to claim 7, wherein the first and second calculation units sequentially add or subtract calculation values of predetermined data patterns or byte patterns to or from digital data or byte data that is the object of the addition or subtraction.

9. The data protection processing device according to claim 7, further comprising:
a memory which stores information relating to the predetermined numerical values or the predetermined byte code, information relating to the predetermined number of items, and information relating to the predetermined calculation values; and
an information altering unit which alters at least one from among the information relating to the predetermined numerical values or the predetermined byte code, the information relating to the predetermined number of items, and the information relating to the predetermined calculation values that are stored in the memory.

10. A modem device comprising:
a data compression unit which performs data compression processing on digital data to be transmitted based on a normalized data compression standard;
a first determination unit which converts digital data that has undergone data compression processing by the data compression unit into byte data, sequentially reads the converted byte data, and determines whether or not the read byte data forms a predetermined byte code;
a first calculation unit which adds predetermined calculation values to or subtracts predetermined calculation values from either all of or a portion of a predetermined number of items of byte data that are continuous after byte data that is determined as a result of the determination by the first determination unit to form the predetermined byte code;
a first output unit which outputs the byte data added or subtracted in the first calculation unit;
a second determination unit which converts received digital data into byte data, sequentially reads the converted byte data, and determines whether or not the read byte data forms a predetermined byte code;
a second calculation unit which adds the predetermined calculation values to or subtracts the predetermined calculation values from either all of or a portion of a predetermined number of items of byte data that are continuous after byte data that is determined as a result of the determination by the second determination unit to form the predetermined byte code; and
a data decompression unit which converts byte data subtracted or added in the second calculation unit into digital data and performs data decompression processing on the converted digital data based on the data decompression standard.

11. The modem device according to claim 10, wherein the first and second calculation units sequentially add or subtract calculation values of predetermined data patterns or byte patterns to or from digital data or byte data that is the object of the addition or subtraction.

12. The modem device according to claim 10, wherein the modem device further comprises:
a memory which stores information relating to the predetermined numerical values or the predetermined byte code, information relating to the predetermined number of items, and information relating to the predetermined calculation values; and
an information altering unit which alters at least one from among the information relating to the predetermined numerical values or the predetermined byte code, the information relating to the predetermined number of items, and the information relating to the predetermined calculation values that are stored in the memory.

13. A data communications system comprising:
a data transmitting device; and
a data receiving device which receives data transmitted by the data transmitting device,
wherein the data transmitting device includes
a first determination unit which reads transmission data in sequence and determines whether or not the read data includes digital data having a predetermined numerical value;
a first calculation unit which adds predetermined calculation values to or subtracts predetermined calculation values from either all of or a portion of a predetermined number of items of digital data that are continuous after the digital data having the predetermined numerical value when it is determined by the first determination unit that the data contains digital data having a predetermined numerical value; and
a transmitting unit which transmits data that has undergone calculation processing by the first calculation unit, and
wherein the data receiving device includes
a receiving unit which receives data transmitted by the data transmitting unit;
a second determination unit which reads in sequence data received by the data receiving unit and determines whether or not the read data includes digital data having the predetermined numerical value; and
a second calculation unit which adds the predetermined calculation values to or subtracts the predetermined calculation values from either all of or a portion of the predetermined number of items of digital data that are continuous after the digital data having the predetermined numerical value when it is determined by the second determination unit that the data contains digital data having a predetermined numerical value.

14. The data communications system according to claim 13, wherein the data transmitting device and data receiving device are connected to each other via a network such as the Internet.

15. The data communications system according to claim 13, wherein the first and second calculation units sequentially add or subtract calculation values of predetermined data patterns or byte patterns to or from digital data or byte data that is the object of the addition or subtraction.

16. The data communications system according to claim 13, wherein the data transmitting device and data receiving device further comprising:
a memory which stores information relating to the predetermined numerical values or the predetermined byte code, information relating to the predetermined number of items, and information relating to the predetermined calculation values; and
an information altering unit which synchronizes the data transmitting device and data receiving device and alters at least one from among the information relating to the predetermined numerical values or the predetermined byte code, the information relating to the predetermined number of items, and the information relating to the predetermined calculation values that are stored in the memory.

17. A data protection processing method comprising:
a reading step of reading in sequence continuous digital data;
a determination processing step of determining whether or not digital data read in the reading step forms numerical values having a predetermined continuous pattern; and
a calculation processing step of adding predetermined calculation values to or subtracting predetermined calculation values from either all of or a portion of a predetermined number of items of digital data that are continuous after digital data that is determined as a result of the determination in the determination processing step to form numerical values having the predetermined continuous pattern.

18. The data protection processing method according claim 17, wherein, in the calculation processing step, calculation values of predetermined data patterns or byte patterns are sequentially added to or subtracted from digital data or byte data that is the object of the addition or subtraction.

19. The data protection processing method according to claim 17, further comprising an information altering step of altering at least one of information relating to the predetermined numerical values or the predetermined byte code, information relating to the predetermined number of items, and information relating to the predetermined calculation values.

20. A data protection processing method comprising:
a reading step of converting binary data input serially into byte data and reading the byte data in sequence;
a determination processing step of determining whether or not the byte data read in the reading step forms a predetermined byte code;
a calculation processing step of adding predetermined calculation values to or subtracting predetermined calculation values from either all of or a portion of a predetermined number of items of byte data that are continuous after byte data that is determined as a result of the determination in the determination processing step to form the predetermined byte code; and
an output step of converting byte data calculated in the calculation processing step in to binary data and serially outputs the binary data.

21. The data protection processing method according claim 20, wherein, in the calculation processing step, calculation values of predetermined data patterns or byte patterns are sequentially added to or subtracted from digital data or byte data that is the object of the addition or subtraction.

22. The data protection processing method according to claim 20, further comprising an information altering step of altering at least one of information relating to the predetermined numerical values or the predetermined byte code, information relating to the predetermined number of items, and information relating to the predetermined calculation values.

23. A data protection processing method comprising:
a holding step of converting binary data input serially into byte data and temporarily holding the converted byte data in respective predetermined data frames;
a data extraction processing step of extracting a portion of the byte data forming the predetermined data frames held in the holding step to serve as data for processing;
a determination processing step of sequentially reading from the data extraction processing step the byte data forming the data for processing and determining whether or not the read byte data forms a predetermined byte code;
a calculation processing step of adding predetermined calculation values to or subtracting predetermined calculation values from either all of or a portion of a predetermined number of items of byte data that are continuous after byte data that is determined as a result of the determination in the determination processing step to form the predetermined byte code;
a data frame reconstruction processing step of reconstructing the predetermined data frames using byte data calculated in the calculation processing step; and
an output step of converting the data frames reconstructed in the data frame reconstruction processing step into binary data and serially outputting the binary data.

24. The data protection processing method according claim 23, wherein, in the calculation processing step, calculation values of predetermined data patterns or byte patterns are sequentially added to or subtracted from digital data or byte data that is the object of the addition or subtraction.

25. The data protection processing method according to claim 23, further comprising an information altering step of altering at least one of information relating to the predetermined numerical values or the predetermined byte code, information relating to the predetermined number of items, and information relating to the predetermined calculation values.

26. A data protection processing method comprising:
a reading step of sequentially reading transmission data or received data forming continuous digital data;
a first determination processing step of determining whether or not the transmission data or received data read in the reading step contains digital data having a predetermined numerical value;
a first calculation processing step of adding predetermined calculation values to or subtracting predetermined calculation values from either all of or a portion of a predetermined number of items of digital data that are continuous after the digital data having the predetermined numerical value when it is determined in the first determination processing step that the transmission data or received data contains digital data having a predetermined numerical value;
a second determination processing step of sequentially reading received data or transmission data forming continuous digital data and determining whether or not the read received data or transmission data contains digital data having a predetermined numerical value; and
a second calculation processing step of adding predetermined calculation values to or subtracting predetermined calculation values from either all of or a portion of a predetermined number of items of digital data that are continuous after the digital data having the predetermined numerical value when it is determined in the second determination processing step that the received data or transmission data contains digital data having a predetermined numerical value.

27. The data protection processing method according to claim 26, wherein, in the first and second calculation processing steps, calculation values of predetermined data patterns or byte patterns are sequentially added to or subtracted from digital data or byte data that is the object of the addition or subtraction.

28. The data protection processing method according to claim 26, further comprising an information altering step of altering at least one of information relating to the predetermined numerical values or the predetermined byte code, information relating to the predetermined number of items, and information relating to the predetermined calculation values.

29. A data protection processing method comprising:
a first reading step of converting transmission data or received data in the form of serially input binary data into byte data and sequentially reading the byte data;
a first determination processing step of determining whether or not the byte data read in the first reading step forms a predetermined byte code;
a first calculation processing step of adding predetermined calculation values to or subtracting predetermined calculation values from either all of or a portion of a predetermined number of items of byte data that are continuous after byte data that is determined as a result of the determination in the first determination processing step to form the predetermined byte code;
a first output step of converting byte data added or subtracted in the first calculation processing step into binary data and serially outputting the binary data as transmission data or received data;
a second reading step of converting received data or transmission data in the form of serially input binary data into byte data and sequentially reading the byte data;
a second determination processing step of determining whether or not the byte data read in the second reading step forms the predetermined byte code;
a second calculation processing step of adding the predetermined calculation values to or subtracting the predetermined calculation values from either all of or a portion of a predetermined number of items of byte data that are continuous after byte data that is determined as a result of the determination in the second determination processing step to form the predetermined byte code; and
a second output step of converting byte data added or subtracted in the second calculation processing step into binary data and serially outputting the binary data as received data or transmission data.

30. The data protection processing method according to claim 29, wherein, in the first and second calculation processing steps, calculation values of predetermined data patterns or byte patterns are sequentially added to or subtracted from digital data or byte data that is the object of the addition or subtraction.

31. The data protection processing method according to claim 29, further comprising an information altering step of altering at least one of information relating to the predetermined numerical values or the predetermined byte code, information relating to the predetermined number of items, and information relating to the predetermined calculation values.

32. A data protection processing method comprising:
a first holding step of converting transmission data or received data in the form of serially input binary data into byte data and temporarily holding the converted byte data in respective predetermined data frames;
a first data extraction processing step of extracting from the first holding step a portion of the byte data forming the predetermined data frames to serve as data for processing;
a first determination processing step of sequentially reading from the first data extraction processing step the byte data forming the data for processing and determining whether or not the read byte data forms a predetermined byte code;
a first calculation processing step of adding predetermined calculation values to or subtracting predetermined calculation values from either all of or a portion of a predetermined number of items of byte data that are continuous after byte data that is determined as a result of the determination in the first determination processing step to form the predetermined byte code;
a first data frame reconstruction processing step of reconstructing the predetermined data frames using byte data calculated in the first calculation processing step;
a first output step of converting the data frames reconstructed in the first data frame reconstruction processing step into binary data and serially outputting the binary data as transmission data or received data;
a second holding step of converting received data or transmission data in the form of serially input binary data into byte data and temporarily holding the converted byte data in respective predetermined data frames;
a second data extraction processing step of extracting from the second holding step a portion of the byte data forming the predetermined data frames to serve as data for processing;
a second determination processing step of sequentially reading from the second data extraction processing step the byte data forming the data for processing and determining whether or not the read byte data forms a predetermined byte code;
a second calculation processing step of adding the predetermined calculation values to or subtracting the predetermined calculation values from either all of or a portion of a predetermined number of items of byte data that are continuous after byte data that is determined as a result of the determination in the second determination processing step to form the predetermined byte code;
a second data frame reconstruction processing step of reconstructing the predetermined data frames using byte data subtracted or added in the second calculation processing step; and
a second output step of converting the data frames reconstructed in the second data frame reconstruction processing step into binary data and serially outputting the binary data as received data or transmission data.

33. The data protection processing method according to claim 32, wherein, in the first and second calculation processing steps, calculation values of predetermined data patterns or byte patterns are sequentially added to or subtracted from digital data or byte data that is the object of the addition or subtraction.

34. The data protection processing method according to claim 32, further comprising an information altering step of altering at least one of information relating to the predetermined numerical values or the predetermined byte code, information relating to the predetermined number of items, and information relating to the predetermined calculation values.
